(19) United States
(12) Patent Application Publication
(10) Pub. No.: US 2026/0156431 A1
(43) Pub. Date: Jun. 4, 2026

(54) Themed Ornaments with Internet Radio Receiver and Enhanced Delivery of Three-Dimensional Spatial Sound in AR/VR Headsets

(71) Applicants: Donald Spector, Jupiter, FL (US); Lisa PAMINTUAN, WEST PALM BEACH, FL (US)

(72) Inventors: Donald Spector, Jupiter, FL (US); Lisa PAMINTUAN, WEST PALM BEACH, FL (US)

(21) Appl. No.: 19/339,265

(22) Filed: Sep. 24, 2025

Related U.S. Application Data
(63) Continuation-in-part of application No. 18/213,404, filed on Jun. 23, 2023, now Pat. No. 12,507,007.

(51) Int. Cl. H04S 7/00; H04R 5/033

(52) U.S. Cl. CPC H04S 7/304; H04R 5/033; H04S 2400/11; H04S 2400/13

(57) ABSTRACT

An augmented or virtual reality (AR/VR) headset is provided with a first set of speakers located within a headset housing and a second set of speakers positioned in ear extensions. A sound-processing module distributes audio signals across the sets of speakers to render an immersive three-dimensional spatial audio field. In certain embodiments, the module adjusts inter-aural timing and level differences responsive to head-tracking data to maintain stable localization cues during user movement. The ear extensions can be detachable and may be communicatively coupled to the module when attached. The module can apply head-related transfer functions, beamforming, adaptive filtering, or environmental mapping to preserve externalization and front-back discrimination. The systems may be used with internet-delivered audio or local sources and can be coordinated with themed visual displays.

### CROSS-REFERENCE TO RELATED APPLICATIONS

This application is a Continuation-in-Part of U.S. patent application Ser. No. 18/213,404, filed Jun. 23, 2023, the entire disclosure of which is incorporated by reference herein in its entirety. The parent application received a Notice of Allowance on Jul. 28, 2025 and the issue fee has been paid.

### FIELD OF THE INVENTION

The present invention relates to (i) internet-connected receivers and themed audio-visual systems that coordinate audio content with displays or projection imagery, and (ii) immersive audio delivery in augmented reality (AR) and virtual reality (VR) headsets using combined internal and external speaker arrays with spatial sound processing.

### BACKGROUND

Internet-enabled audio systems can receive streams from online services and local playlists and may coordinate those streams with visual elements. Conventional AR/VR headsets typically rely on a single speaker set or headphones, which can limit externalization and source localization. There is a need for improved approaches that provide stable, immersive, three-dimensional sound fields while accommodating head movement and the acoustic environment around the listener.

### SUMMARY OF THE INVENTION

In one aspect, systems and methods provide themed, internet-connected speakers and visual displays to deliver synchronized audio-visual experiences. In another aspect, AR/VR headsets include dual speaker arrays—internal speakers within the headset housing and speakers positioned in ear extensions—coordinated by a sound processing module that renders three-dimensional spatial audio. Head tracking, environmental mapping, and adaptive signal processing can be used to maintain stable localization cues during user movement.

### BRIEF DESCRIPTION OF THE DRAWINGS

FIG. 9 is a schematic view of an AR/VR headset showing internal speakers (110a, 110b), ear-extension speakers (120a, 120b), a sound processing module (130), and head-tracking sensors (140) configured to generate a spatial audio field (150).

### DETAILED DESCRIPTION

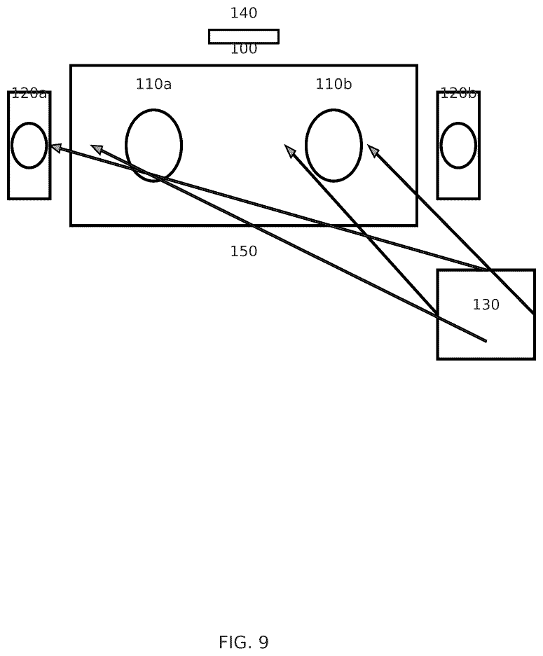

Referring to FIG. 9, headset 100 houses internal speakers 110a and 110b positioned within the headset housing to provide localized audio cues proximate the user's ears. Ear extensions 120a and 120b each include at least one external speaker physically coupled to the housing to transmit directional audio signals synchronized with the internal speakers. A sound processing module 130 communicates with both internal and external speakers to synthesize an immersive three-dimensional sound field 150. Head-tracking sensors 140 supply motion and pose data; the module compensates for head movement to maintain stable sound source localization. In certain embodiments, the ear extensions are detachable; in others, they are integrated into the headband.

The sound processing module may utilize head-related transfer functions (HRTFs), beamforming, and adaptive filtering. In AR scenarios, environmental mapping may be used to infer virtual source positions relative to real-world surfaces. Machine-learning models can estimate gain and delay parameters for the combined arrays to preserve externalization and front-back discrimination while minimizing comb filtering between arrays.

1. A system for delivering three-dimensional spatial sound in an augmented reality (AR) or virtual reality (VR) headset, comprising:
(a) a first set of speakers positioned within an interior of a headset housing;
(b) a second set of speakers located in ear extensions physically connected to the headset; and
(c) a sound processing module configured to distribute audio signals across the first and second sets of speakers to render an immersive three-dimensional spatial audio field.

2. The system of claim 1, wherein the sound processing module is configured to adjust inter-aural timing and level differences responsive to head-tracking data in real time.

3. The system of claim 1, wherein the ear extensions are detachable from the headset housing and communicatively coupled to the sound processing module when attached.

4. The system of claim 1, wherein the sound processing module applies one or more of head-related transfer functions, beamforming, adaptive filtering, or environmental mapping to maintain stable localization cues during user motion.
